(19) United States
(12) Patent Application Publication
(10) Pub. No.: US 2019/0062677 A1
(43) Pub. Date: Feb. 28, 2019

(54) COPOLYMERS FOR IMPROVING THE RINSING POWER

(71) Applicant: Henkel AG & Co. KGaA, Duesseldorf (DE)

(72) Inventors: Inga Kerstin Vockenroth, Duesseldorf (DE); Doris Dahlmann, Duesseldorf (DE); Ard de Zeeuw, Duesseldorf (DE); Thomas Moeller, Duesseldorf (DE)

(73) Assignee: Henkel AG & Co. KGaA, Duesseldorf (DE)

(21) Appl. No.: 16/170,691

(22) Filed: Oct. 25, 2018

Related U.S. Application Data
(63) Continuation of application No. PCT/EP2016/059198, filed on Apr. 25, 2016.

(51) Int. Cl. C11D 11/00; C11D 3/37; C08F 210/02

(52) U.S. Cl. CPC C11D 11/0023; C08F 2800/10; C08F 210/02; C11D 3/3757

(57) ABSTRACT

A dishwashing detergent having improved rinsing power, comprising, relative to the total weight of the dishwashing detergent, 0.1 to 25.0 wt % of a copolymer obtainable by the polymerization of 70-95 mol % of at least one C₂₋₄ alkene monomer; and 5-30 mol % of at least one ethylenically unsaturated C₃₋₈ carboxylic acid monomer or a salt thereof. The use of this dishwashing detergent and a method for washing dishes in a dishwasher using this dishwashing detergent and the use of the copolymers for improving the rinsing power of the dishwashing detergent.

### FIELD OF THE INVENTION

The present invention relates to a dishwashing agent having improved rinsing performance, to the use of said dishwashing agent and to a method for automatic dishwashing using said dishwashing agent.

### BACKGROUND OF THE INVENTION

These days, greater expectations are often placed on automatically washed dishes than on manually washed dishes. For instance, even dishes completely cleared of food waste are not considered to be immaculate if, following the automatic dishwashing, they still have off-white flecks that result from the water hardness or other mineral salts and stem from dried-on water droplets owing to a lack of wetting agent. Such a formation of flecks and streaks can generally be seen on all kinds of surfaces (porcelain, glass, plastics, stainless steel), but in particular on glass surfaces.

Rinse aids are used in dishwashing formulations in order to obtain gleaming and fleck-less dishes. On account of a formation of film on the dishes provided by said aids, the water is intended to completely run off the washware, as far as possible, such that the surfaces shine at the end of the washing program, without residue or blemishes. Although the use of rinse aids of this kind is known in the art, there remains a need for dishwashing agents exhibiting improved rising performance.

The problem addressed by the present invention therefore consisted in providing a dishwashing agent having improved rinsing performance.

It has surprisingly been found that the copolymers according to the invention, when used in common dishwashing formulations, lead to improved film-formation on washware surfaces, as a result of which the water can run off the washware in a thin, continuous film, such that no water droplets, streaks or films are left behind during the subsequent drying process. This results in the suppression of streak-formation on washware, in particular glass, and the drying and rinsing performance is significantly improved even during low-temperature washing cycles (<50° C.).

A first aspect of the present invention therefore relates to a dishwashing agent, in particular an automatic dishwashing agent, containing, based on the total weight of the dishwashing agent, 0.1 to 25.0 wt. %, in particular 0.5 to 10 wt. %, of a copolymer that can be obtained by polymerization of
a) 70-95 mol. %, in particular 75-92 mol. %, particularly preferably 77-85 mol. %, of at least one C₂₋₄ alkene monomer, in particular ethylene or propylene; and
b) 5-30 mol. %, in particular 8-25 mol. %, particularly preferably 15-23 mol. %, of at least one ethylenically unsaturated C₃₋₈ carboxylic acid monomer, in particular acrylic or methacrylic acid, or a salt thereof.

### BRIEF SUMMARY OF THE INVENTION

The object of the present invention is also the use of a dishwashing agent according to the invention in an automatic dishwashing method, in particular the use for improving the rinsing performance when washing dishes in an automatic dishwasher.

A further object of the invention is an automatic dishwashing method in which a dishwashing agent according to the invention is used, in particular for the purpose of improving rinsing performance.

Finally, the use of a copolymer as defined above for improving the rinsing performance of an automatic dishwashing agent is also an object of the present invention.

These and other aspects, features and advantages of the invention will become apparent to a person skilled in the art by studying the following detailed description and the claims. Any feature from one aspect of the invention can be used in any other aspect of the invention. Furthermore, it will readily be understood that the examples contained herein are intended to describe and illustrate but not to limit the invention and that, in particular, the invention is not limited to these examples. Unless indicated otherwise, all percentages are indicated in terms of wt. %. Numerical ranges that are indicated in the format “from x to y” also include the cited values. If several preferred numerical ranges are indicated in this format, it is self-evident that all ranges that result from the combination of the various endpoints are also included.

“At least one”, as used herein, means one or more, i.e., one, two, three, four, five, six, seven, eight, nine, or more. In relation to an ingredient, the expression refers to the type of ingredient and not to the absolute number of molecules. “At least one alkene” thus means, for example, at least one type of alkene, i.e., that one type of alkene or a mixture of a plurality of different alkenes can be used. Together with weight data, the expression refers to all compounds of the indicated type that are contained in the composition/mixture, that is to say that the composition does not contain any other compounds of this type beyond the indicated amount of the corresponding compounds.

Unless explicitly indicated otherwise, all percentages that are cited in connection with the compositions described herein refer to wt. %, in each case based on the mixture in question.

In the context of the present invention, unless otherwise stated, fatty acids and/or fatty alcohols and/or derivatives thereof represent branched or unbranched carboxylic acids and/or alcohols and/or the derivatives thereof preferably having 6 to 22 carbon atoms. In particular, the oxo alcohols and derivatives thereof which can be obtained according to Roelen's oxo synthesis, for example, can also be used accordingly.

Whenever in the following alkaline-earth metals are specified as counterions for monovalent anions, this means that the alkaline-earth metal is naturally present only in half of the substance amount, sufficient for charge balancing, of the anion.

Substances that are also used as ingredients of cosmetic agents are also designated in the following according to the International Nomenclature of Cosmetic Ingredients (INCI) as appropriate. Chemical compounds have an English INCI designation, botanical ingredients are listed exclusively in Latin, in accordance with Linné, and what are known as common names such as “water”, “honey” or “sea salt” are also specified in Latin. The INCI designations can be found in the International Cosmetic Ingredient Dictionary and Handbook—Seventh Edition (1997), which is published by The Cosmetic, Toiletry, and Fragrance Association (CTFA), 1101 17th Street, NW, Suite 300, Washington DC 20036, USA and contains over 9,000 INCI designations and references to over 37,000 trade names and technical designations, including the associated distributors from over 31 countries. The International Cosmetic Ingredient Dictionary and Handbook assigns the ingredients one or more chemical classes, for example Polymeric Ethers, and one or more functions, for example Surfactants - Cleansing Agents, which it then explains in greater detail and to which reference may also subsequently be made.

### DETAILED DESCRIPTION OF THE INVENTION

The copolymer used according to the invention can be obtained by polymerization of alkenes with ethylenically unsaturated carboxylic acids. In particular ethylene, propylene and butylene are suitable as alkenes. Suitable carboxylic acid monomers include in particular acrylic and methacrylic acid, but also crotonic acid and dicarboxylic acids, such as maleic acid or the anhydride thereof, itaconic acid and fumaric acid. Copolymers of ethylene and acrylic acid having an acid content of 5-30, in particular 8-25, more preferably 15-23 mol. % are particularly preferred. The carboxylic acid monomers can be used in the form of free acids or in the form of the salts thereof, in particular in the form of alkali metal salts or ammonium salts. Alternatively, the copolymer can also be neutralized after polymerization, in whole or in part, using suitable alkaline reagents. The degree of neutralization allows for example the solubility (in water or aqueous solvents) of the solid proportion to be achieved to be set, along with the average particle size in the case of dispersion of the polymer.

The copolymers can be obtained using polymerization methods that are known per se in the prior art. The polymerization is preferably radical polymerization, in which in particular radical initiators can be used.

The molecular weight Mw of the polymers used is preferably in the range of from 10,000-1,000,000. Unless indicated otherwise, the molecular weights indicated in the present text refer to the number average of the molecular weight (Mn). The molecular weight Mn can be determined by means of gel permeation chromatography (GPC) according to DIN 55672-1:2007-08 with THF as an eluent. Except where indicated otherwise, the listed molecular weights are those which are determined by means of GPC. The number average of the molecular weight Mn can also be determined by means of GPC, as specified above.

The copolymers used according to the invention are preferably contained in the dishwashing agents at 0.1-25 wt. %, particularly preferably at 0.5-10 wt. % and even more preferably at approximately 5.0 wt. %, based on the total weight of the dishwashing agent. Absolute quantities are typically in the range of from 0.1 to 5 g/job, preferably in the range of from 0.1 to 2 g/job, even more preferably approximately 1 g/job.

“Approximately” as used herein in connection with a numerical value refers to the numerical value ±10%, preferably ±5%.

The agent according to the invention may contain at least one further component, preferably selected from the group consisting of surfactants, in particular non-ionic and/or anionic surfactants, builders, enzymes, thickeners, sequestering agents, electrolytes, corrosion inhibitors, in particular silver protectants, glass corrosion inhibitors, foam inhibitors, dyes, fragrances, bitterns and antimicrobial active ingredients.

The agents described herein preferably contain at least one non-ionic surfactant. All non-ionic surfactants that are known to a person skilled in the art can be used as non-ionic surfactants.

Suitable non-ionic surfactants include alkyl glycosides of general formula RO(G)ₓ, for example, in which R represents a primary straight-chain or methyl-branched aliphatic functional group, in particular an aliphatic functional group that is methyl-branched in the 2 position, having 8 to 22, preferably 12 to 18 C atoms, and G is the symbol that represents a glycose unit having 5 or 6 C atoms, preferably glucose. The degree of oligomerization x, which indicates the distribution of monoglycosides and oligoglycosides, is any number between 1 and 10; x is preferably between 1.2 and 1.4.

Another class of non-ionic surfactants that can be used, which can be used either as the sole non-ionic surfactant or in combination with other non-ionic surfactants, are alkoxylated, preferably ethoxylated or ethoxylated and propoxylated fatty acid alkyl esters, preferably having 1 to 4 carbon atoms in the alkyl chain.

Non-ionic surfactants of the aminoxide type, for example N-cocoalkyl-N,N-dimethylamine oxide and N-tallow alkyl-N,N-dihydroxyethylamine oxide, and of the fatty acid alkanolamides, can also be suitable. The amount of these non-ionic surfactants is preferably no more than that of the ethoxylated fatty alcohols, particularly no more than half thereof.

Additional suitable surfactants are the polyhydroxy fatty acid amides that are known as PHFAs.

Preferably, however, low-foaming non-ionic surfactants are used, in particular alkoxylated, especially ethoxylated, low-foaming non-ionic surfactants. Especially preferably, the automatic dishwashing agents contain non-ionic surfactants from the group of the alkoxylated alcohols.

Non-ionic surfactants having a melting point above room temperature are particularly preferred. Non-ionic surfactant/s having a melting point above 20° C., preferably above 25° C., particularly preferably between 25 and 60° C., and in particular between 26.6 and 43.3° C. is/are particularly preferred.

Surfactants that are preferably used come from the groups of the alkoxylated non-ionic surfactants, in particular the ethoxylated primary alcohols and mixtures of these surfactants with structurally complicated surfactants such as polyoxypropylene/polyoxyethylene/polyoxypropylene ((PO/EO/PO) surfactants). Such (PO/EO/PO) non-ionic surfactants are also characterized by good foam control.

Those non-ionic surfactants having alternating ethylene oxide and alkylene oxide units are particularly preferred. Among these, in turn, surfactants having EO-AO-EO-AO blocks are preferred, with one to ten EO groups and AO groups being bonded to each other in each case, before a block follows from the respective other groups. In this case, non-ionic surfactants of general formula

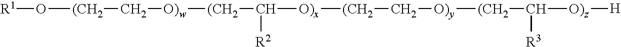

are preferred, in which R¹ represents a straight-chain or branched, saturated or mono- or polyunsaturated C₆₋₂₄ alkyl functional group or alkenyl functional group; each R² and R³ group is selected independently of one another from —CH₃, —CH₂CH₃, —CH₂CH₂—CH₃, CH(CH₃)₂ and the indices w, x, y, z, independently of one another, represent integers from 1 to 6.

Therefore, in particular, non-ionic surfactants which comprise a C₉₋₁₅ alkyl functional group having 1 to 4 ethylene oxide units, followed by 1 to 4 propylene oxide units, followed by 1 to 4 ethylene oxide units, followed by 1 to 4 propylene oxide units, are preferred.

Preferred non-ionic surfactants in this case are those of general formula

R¹—CH(OH)CH₂O-(AO)_{w}-(A′O)ₓ-(A″O)_{y}-(A′″O)_{z}—R²,

in which
R¹ represents a straight-chain or branched, saturated or mono- or polyunsaturated C₆₋₂₄ alkyl functional group or alkenyl functional group;
R² represents H or a linear or branched hydrocarbon functional group having 2 to 26 carbon atoms;
A, A′, A″ and A′″ represent, independently of one another, a functional group from the group
—CH₂CH₂, —CH₂CH₂—CH₂, —CH₂—CH(CH₃), —CH₂—CH₂—CH₂—CH₂, —CH₂—CH(CH₃)—CH₂—, —CH₂—CH(CH₂—CH₃),
w, x, y and z represent values between 0.5 and 120, where x, y and/or z can also be 0.

In particular those end-capped poly(oxyalkylated) non-ionic surfactants are preferred which, according to formula R¹O[CH₂CH₂O]xCH₂CH(OH)R², in addition to a functional group R¹, which represents linear or branched, saturated or unsaturated, aliphatic or aromatic hydrocarbon functional groups having 2 to 30 carbon atoms, preferably having 4 to 22 carbon atoms, also have a linear or branched, saturated or unsaturated, aliphatic or aromatic hydrocarbon functional group R² having 1 to 30 carbon atoms, where x represents values between 1 and 90, preferably values between 30 and 80, and in particular values between 30 and 60.

Surfactants of formula R¹O[CH₂CH(CH₃)O]ₓ[CH₂CH₂O]_{y}CH₂CH(OH)R² are particularly preferred, in which R¹ represents a linear or branched aliphatic hydrocarbon functional group having 4 to 18 carbon atoms or mixtures thereof, R² represents a linear or branched hydrocarbon functional group having 2 to 26 carbon atoms or mixtures thereof, and x represents values between 0.5 and 1.5, and y represents a value of at least 15.

The group of these non-ionic surfactants includes for example the C₂₋₂₆ fatty alcohol (PO)₁-(EO)₁₅₋₄₀-2-hydroxyalkyl ethers, in particular including the C₈₋₁₀ fatty alcohol (PO)₁-(EO)₂₂-2-hydroxydecyl ethers. Furthermore, those end-capped poly(oxyalkylated) non-ionic surfactants of formula R¹O[CH₂CH₂O]ₓ[CH₂CH(R³)O]_{y}CH₂CH(OH)R² are particularly preferred in which R¹ and R², independently of one another, represent a linear or branched, saturated or mono- or polyunsaturated hydrocarbon functional group having 6 to 26 carbon atoms, R³, independently of one another, is selected from —CH₃, —CH₂CH₃, —CH₂CH₂—CH₃, —CH(CH₃)₂, but preferably represents —CH₃, and x and y, independently of one another, represents values between 1 and 32, with non-ionic surfactants in which R³═—CH₃ and having values for x of from 15 to 32 and for y of from 0.5 and 1.5 being very particularly preferred.

Further preferred non-ionic surfactants which can be used are the end-capped poly(oxyalkylated) non-ionic surfactants of formula R¹O[CH₂CH(R³)O]x[CH₂]kCH(OH)[CH₂]jOR², in which R¹ and R² represent linear or branched, saturated or unsaturated, aliphatic or aromatic hydrocarbon functional groups having 1 to 30 carbon atoms, R³ represents H or a methyl, ethyl, n-propyl, iso-propyl, n-butyl, 2-butyl or 2-methyl-2-butyl functional group, x represents values between 1 and 30, and k and j represent values between 1 and 12, preferably between 1 and 5. If the value is x≥2, each R³ in the above formula R¹O[CH₂CH(R³)O]x[CH₂]kCH(OH)[CH₂]jOR² can be different. R¹ and R² are preferably linear or branched, saturated or unsaturated, aliphatic or aromatic hydrocarbon functional groups having 6 to 22 carbon atoms, with functional groups having 8 to 18 C atoms being particularly preferred. For the functional group R³, H, —CH₃ or —CH₂CH₃ are particularly preferred. Particularly preferred values for x are in the range of from 1 to 20, in particular from 6 to 15.

As described above, each R³ in the above formula can be different if x≥2. As a result, the alkylene oxide unit in the square brackets can be varied. For example, if x represents 3, the functional group R³ can be selected in order to form ethylene oxide (R³═H) or propylene oxide (R³═CH3) units, which can be joined together in any sequence, for example (EO)(PO)(EO), (EO)(EO)(PO), (EO)(EO)(EO), (PO)(EO)(PO), (PO)(PO)(EO) and (PO)(PO)(PO). The value 3 for x has been selected here by way of example and can by all means be greater, in which case the range of variation increases as the values for x increase and includes a large number of (EO) groups combined with a small number of (PO) groups, for example, or vice versa.

Particularly preferred end-capped poly(oxyalkylated) alcohols of the above formula have values of k=1 and j=1, and therefore the previous formula is simplified to R¹O[CH₂CH(R³)O]XCH₂CH(OH)CH₂OR². In the latter-mentioned formula, R¹, R² and R³ are as defined above and x represents numbers from 1 to 30, preferably 1 to 20, and in particular 6 to 18. Surfactants in which the functional groups R¹ and R² have 9 to 14 C atoms, R³ represents H, and x assumes values from 6 to 15 are particularly preferred.

Finally, the non-ionic surfactants of general formula

R¹—CH(OH)CH₂O-(AO)₂—R²

have proven to be particularly effective, in which
R¹ represents a straight-chain or branched, saturated or mono- or polyunsaturated C₆₋₂₄ alkyl functional group or alkenyl functional group;
R² represents a linear or branched hydrocarbon functional group having 2 to 26 carbon atoms;
A represents a functional group from the group CH₂CH₂, CH₂CH₂CH₂, CH₂CH(CH₃), preferably CH₂CH₂, and
w represents values between 1 and 120, preferably 10 to 80, in particular 20 to 40.

The group of these non-ionic surfactants includes, for example, the C₄₋₂₂ fatty alcohol-(EO)₁₀₋₈₀-2-hydroxyalkyl ethers, in particular including the C₈₋₁₂ fatty alcohol-(EO)₂₂-2-hydroxydecyl ethers and the C₄₋₂₂ fatty alcohol-(EO)₄₀₋₈₀-2-hydroxyalkyl ethers.

In various embodiments of the invention, the corresponding non-end-capped hydroxy mixed ethers can also be used instead of the above-defined end-capped hydroxy mixed ethers. These can satisfy the above formulas, where R² is hydrogen, however, and R¹, R³, A, A′, A″, A″′ w, x, y and z are as defined above.

The agents described herein, which include at least one non-ionic surfactant, preferably a non-ionic surfactant from the group of hydroxy mixed ethers, contain the surfactant, in various embodiments, in an amount of at least 5 wt. %, preferably at least 10 wt. %, based on the total weight of the agent. In specific embodiments, the amount can be more than 10 wt. %, for example 11-15 wt. %. The absolute amounts used per application can be for example in the range of from 1.2-10 g/job, preferably in the range of from 2-5 g/job.

All anionic surface-active substances are suitable for use as anionic surfactants in the washing or cleaning agents. These are characterized by a water-solubilizing, anionic group such as a carboxylate, sulfate, sulfonate or phosphate group and a lipophilic alkyl group having approximately 8 to 30 C atoms. In addition, glycol or polyglycol ether groups, ester, ether and amide groups as well as hydroxyl groups can be contained in the molecule. Examples of suitable anionic surfactants are preferably in the form of the sodium, potassium and ammonium and mono-, di- and trialkanolammonium salts having 2 to 4 carbon atoms in the alkanol group.

Preferred anionic surfactants in the washing or cleaning agent are alkyl sulfates, alkyl polyglycol ether sulfates, and ether carboxylic acids having 10 to 18 C atoms in the alkyl group and up to 12 glycol ether groups in the molecule.

Preferred washing or cleaning agents used according to the invention contain at least one surfactant of formula

R¹—O—(AO)ₙ—SO₃⁻X⁺.

In this formula, R¹ represents a linear or branched, substituted or unsubstituted alkyl, aryl or alkylaryl functional group, preferably for a linear, unsubstituted alkyl functional group, particularly preferably for a fatty alcohol functional group. Preferred functional groups R¹ are selected from decyl, undecyl, dodecyl, tridecyl, tetradecyl, pentadecyl, hexadecyl, heptadecyl, octadecyl, nonadecyl, eicosyl functional groups and mixtures thereof, the representatives having an even number of C atoms being preferred. Particularly preferred functional groups R¹ are derived from C₁₂-C₁₈ fatty alcohols, for example from coconut fatty alcohol, tallow fatty alcohol, lauryl, myristyl, cetyl or stearyl alcohol, or from C₁₀-C₂₀ oxo alcohols.

AO represents an ethylene oxide (EO) group or propylene oxide (PO) group, preferably an ethylene oxide group. The index n represents an integer of from 1 to 50, preferably 1 to 20, and in particular 2 to 10. Very particularly preferably, n represents the numbers 2, 3, 4, 5, 6, 7 or 8. X represents a monovalent cation or the n-th part of an n-valent cation, in this case, the alkali metal ions including Na⁺ or K⁺ being preferred, with Na⁺ being extremely preferred. Additional cations X⁺ can be selected from NH₄⁺, ½Zn²⁺, ½Mg²⁺, ½Ca²⁺, ½Mn²⁺, and mixtures thereof.

In summary, particularly preferred washing or cleaning agents contain at least one anionic surfactant selected from fatty alcohol ether sulfates of formula A-1

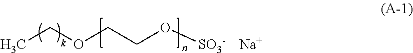

where k=11 to 19, n=2, 3, 4, 5, 6, 7 or 8. Very particularly preferred representatives are Na-C₁₂₋₁₄ fatty alcohol ether sulfates having 2 EO (k=11-13, n=2 in formula A-1).

Further preferred washing or cleaning agents contain, additionally or alternatively, at least one surfactant of formula

R³-A-SO₃⁻Y⁺.

In this formula, R³ represents a linear or branched, substituted or unsubstituted alkyl, aryl or alkylaryl functional group, and the -A-grouping represents —O— or a chemical bond. In other words, sulfate (A=O) or sulfonate (A=chemical bond) surfactants can be described by the above formula. Certain R³ functional groups are preferred depending on the selection of the A grouping. For the sulfate surfactants (A=O), R³ preferably represents a linear, unsubstituted alkyl functional group, particularly preferably a fatty alcohol functional group. Preferred functional groups R¹ are selected from decyl, undecyl, dodecyl, tridecyl, tetradecyl, pentadecyl, hexadecyl, heptadecyl, octadecyl, nonadecyl, eicosyl functional groups and mixtures thereof, the representatives having an even number of C atoms being preferred. Particularly preferred functional groups R¹ are derived from C₁₂-C₁₈ fatty alcohols, for example from coconut fatty alcohol, tallow fatty alcohol, lauryl, myristyl, cetyl or stearyl alcohol, or from C₁₀-C₂₀ oxo alcohols. Y represents a monovalent cation or the n-th part of an n-valent cation, in this case, the alkali metal ions including Na⁺ or K⁺ being preferred, with Na⁺ being extremely preferred. Additional cations Y+ can be selected from NH₄^{′}, ½Zn²⁺, ½Mg²⁺, ½Ca²⁺, ½Mn²⁺, and mixtures thereof.

Such particularly preferred surfactants are selected from fatty alcohol sulfates of formula

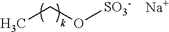

where k=11 to 19. Very particularly preferred representatives are Na-C-₁₂₋₁₄ fatty alcohol sulfates (k=11-13).

For the sulfonate surfactants (A=chemical bond), which are preferred over the sulfate surfactants, R³ preferably represents a linear or branched unsubstituted alkyl functional group. In this case, too, X represents a monovalent cation or the n-th part of an n-valent cation, in this case, the alkali metal ions including Na⁺ or K⁺ being preferred, with Na⁺ being extremely preferred. Additional cations X+ can be selected from NH₄⁺, ½Zn²⁺, ½Mg²⁺, ½Ca²⁺, ½Mn²⁺, and mixtures thereof.

Such extremely preferred surfactants are those selected from linear or branched alkylbenzene sulfonates of formula

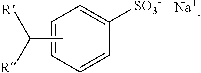

in which R′ and R″ together contain 9 to 19, preferably 11 to 15 and in particular 11 to 13 C atoms. A very particularly preferred representative can be described by the formula:

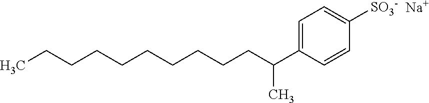

Instead of the above-mentioned surfactants or in conjunction therewith, cationic and/or amphoteric surfactants can also be used.

Suitable amphoteric surfactants are, for example, betaines of formula (Rⁱⁱⁱ)(R^{iv})(R^{v})N⁺CH₂COO⁻, in which Rⁱⁱⁱ denotes an alkyl functional group, which is optionally interrupted by heteroatoms or heteroatom groups, having 8 to 25, preferably 10 to 21 carbon atoms, and R^{iv} and R^{v} denote identical or different alkyl functional groups having 1 to 3 carbon atoms, in particular C₁₀-C₁₈ alkyl dimethyl carboxymethyl betaine and C₁₁-C₁₇alkyl amidopropyl dimethyl carboxymethyl betaine.

Suitable cationic surfactants are, inter alia, the quaternary ammonium compounds of formula (R^{vi})(R^{vii})(R^{viii})(R^{ix})N⁺X⁻, in which R^{vi} to R^{ix} denote four identical or different, and in particular two long-chain and two short-chain, alkyl functional groups, and X⁻ denotes an anion, in particular a halide ion, for example didecyl dimethyl ammonium chloride, alkyl benzyl didecyl ammonium chloride and mixtures thereof. Further suitable cationic surfactants are the quaternary surface-active compounds, in particular having a sulfonium, phosphonium, iodonium or arsonium group, which are also known as antimicrobial active ingredients. By using quaternary surface-active compounds having an antimicrobial effect, the agent can be provided with an antimicrobial effect or the antimicrobial effect that may already be present due to other ingredients can be improved.

In automatic dishwashing agents, the content of cationic and/or amphoteric surfactants is preferably less than 6 wt. %, preferably less than 4 wt. %, very particularly preferably less than 2 wt. %, and in particular less than 1 wt. %. Dishwashing agents that do not contain any cationic or amphoteric surfactants are particularly preferred.

In particular silicates, aluminum silicates (in particular zeolites), carbonates, salts of organic di- and polycarboxylic acids and mixtures of said substances are specified as builders that may be contained in the cleaning or washing agent.

Crystalline layered silicates of general formula NaMSixO₂ₓ₊₁.y H₂O are preferably used, where M represents sodium or hydrogen, x is a number from 1.9 to 22, preferably 1.9 to 4, with 2, 3, or 4 being particularly preferred values for x, and y represents a number from 0 to 33, preferably 0 to 20. The crystalline layered silicates of formula NaMSiₓO₂ₓ₊₁.yH₂O are preferably distributed by Clariant GmbH (Germany) under the brand name Na-SKS. Examples of said silicates are Na-SKS-1 (Na₂Si₂₂O₄₅.xH₂O, kenyaite), Na-SKS-2 (Na₂Si₁₄O₂₉.xH₂O, magadiite), Na-SKS-3 (Na₂Si₈O₁₇.xH₂O) or Na-SKS-4 (Na₂Si₄O₉.xH₂O, makatite). For the purposes of the present invention, crystalline layered silicates of formula NaMSiₓO₂ₓ₊₁.yH₂O, in which x represents 2, are particularly suitable. In particular, both β- and δ-sodium disilicates Na₂Si₂O₅.yH₂O, and also in particular Na-SKS-5 (α-Na₂Si₂O₅), Na-SKS-7 (β-Na₂Si₂O₅, natrosilite), Na-SKS-9 (NaHSi₂O₅.H₂O), Na-SKS-10 (NaHSi₂O₅.3H₂O, kanemite), Na-SKS-11 (t-Na₂Si₂O₅) and Na-SKS-13 (NaHSi₂O₅), but in particular Na-SKS-6 (δ-Na₂Si₂O₅) are preferred.

Automatic dishwashing agents preferably contain a percentage by weight of the crystalline layered silicate of formula NaMSiₓO₂ₓ₊₁.y of from 0.1 to 20 wt. %, preferably 0.2 to 15 wt. % and in particular 0.4 to 10 wt. %, in each case based on the total weight of said agent.

Amorphous sodium silicates having an Na₂O: SiO₂ modulus of from 1:2 to 1:3.3, preferably 1:2 to 1:2.8, and in particular 1:2 to 1:2.6 can also be used which preferably have retarded dissolution and secondary washing properties. The retarded dissolution compared with conventional amorphous sodium silicates may have been caused in a variety of ways, for example by way of surface treatment, compounding, compacting/compression or over-drying. In the context of this invention, the term “amorphous” is understood to mean that the silicates do not supply any sharp X-ray reflexes in X-ray diffraction experiments, such as those that are typical of crystalline substances, but at best elicit one or more maxima of the scattered X-rays, which have a width of several degree units of the diffraction angle.

In the context of the present invention, it is preferable for said silicate(s), preferably alkali silicates, particularly preferably crystalline or amorphous alkali disilicates, to be contained in the agents in amounts of from 3 to 60 wt. %, preferably 8 to 50 wt. % and in particular 20 to 40 wt. %, in each case based on the weight of the automatic dishwashing agent.

It is also possible, of course, to use the generally known phosphates as builder substances, provided that such use should not be avoided for ecological reasons. Amongst the plurality of commercially available phosphates, the alkali metal phosphates, with a particular preference for pentasodium phosphate or pentapotassium triphosphate (sodium tripolyphosphate or potassium tripolyphosphate), are the most important in the washing or cleaning agent industry.

Alkali metal phosphates is the collective designation for the alkali metal (in particular sodium and potassium) salts of the different phosphoric acids, whereby a distinction can be made between metaphosphoric acids (HPO₃)ₙ and orthophosphoric acid H₃PO₄ in addition to higher molecular representatives. The phosphates combine several advantages: They function as alkali carriers, prevent limescale building up on machine parts and lime incrustations in fabrics and also contribute to the cleaning performance.

Phosphates that are particularly important in industry are pentasodium triphosphate, Na₅P₃O₁₀ (sodium tripolyphosphate) and the corresponding potassium salt pentapotassium triphosphate K₅P₃O₁₀ (potassium tripolyphosphate) and corresponding mixed salts (sodium potassium tripolyphosphate). The agents are preferably phosphate-free, however.

If, in the context of the present application, phosphates are used as washing- or cleaning-active substances in the automatic dishwashing agents, preferred agents contain said phosphate(s), preferably alkali metal phosphate(s), particularly preferably pentasodium or pentapotassium triphosphate (sodium or potassium tripolyphosphate), in amounts of from 5 to 80 wt. %, preferably 15 to 75 wt. % and in particular 20 to 70 wt. %, in each case based on the weight of the automatic dishwashing agent.

In particular, the cleaning agents can also contain phosphonates as an additional builder. A hydroxy alkane and/or amino alkane phosphonate is preferably used as a phosphonate compound. Among the hydroxy alkane phosphonates, 1-hydroxyethane-1,1-diphosphonate (HEDP) has particular significance. Possible preferable aminoalkane phosphonates include ethylenediamine tetramethylene phosphonate (EDTMP), diethylentriamine pentamethylene phosphonate (DTPMP) and the higher homologues thereof. Phosphonates are preferably contained in the agents in amounts of from 0.1 to 10 wt. %, in particular in amounts from 0.5 to 8 wt. %, in each case based on the total weight of the cleaning agent.

The alkali carriers are further builders. Alkali metal hydroxides, alkali metal carbonates, alkali metal hydrogen carbonates, alkali metal sesquicarbonates, the above-mentioned alkali silicates, alkali metal silicates, and mixtures of these substances, for example, can be alkali carriers, it being possible in the context of this invention for the alkali carbonates, in particular sodium carbonate, sodium hydrogen carbonate or sodium sesquicarbonate to preferably be used. A builder system containing a mixture of tripolyphosphate and sodium carbonate is particularly preferred. A builder system containing a mixture of tripolyphosphate, sodium carbonate and sodium disilicate is also particularly preferred. On account of their low level of chemical compatibility with the other ingredients of automatic dishwashing agents compared with other builder substances, the optional alkali metal hydroxides are used in only small amounts, preferably in amounts below 10 wt. %, preferably below 6 wt. %, more preferably below 4 wt. %, and in particular below 2 wt. %, in each case based on the total weight of the automatic dishwashing agent. Agents containing, based on the total weight thereof, less than 0.5 wt. % and in particular no alkali metal hydroxides are particularly preferred.

It is particularly preferable to use carbonate(s) and/or hydrogen carbonate(s), preferably alkali carbonate(s), particularly preferably sodium carbonate, in amounts of from 2 to 50 wt. %, preferably 5 to 40 wt. %, and in particular 7.5 to 30 wt. %, in each case based on the weight of the automatic dishwashing agent. Agents containing, based on the weight of the automatic dishwashing agent, less than 20 wt. %, preferably less than 17 wt. %, particularly preferably less than 13 wt. % and in particular less than 9 wt. % carbonate(s) and/or hydrogen carbonate(s), preferably alkali carbonate(s), particularly preferably sodium carbonate, are particularly preferred.

The cleaning agents according to the invention can also contain a sulfopolymer. The percentage by weight of the sulfopolymer with respect to the total weight of the cleaning agent according to the invention is preferably from 0.1 to 20 wt. %, in particular 0.5 to 18 wt. %, particularly preferably 1.0 to 15 wt. %, in particular 4 to 14 wt. %, especially 6 to 12 wt. %. The sulfopolymer is usually used in the form of an aqueous solution, the aqueous solution typically containing 20 to 70 wt. %, in particular 30 to 50 wt. %, preferably approximately 35 to 40 wt. % sulfopolymers.

A copolymeric polysulfonate, preferably a hydrophobically modified copolymeric polysulfonate, is preferably used as the sulfopolymer.

The copolymers can have two, three, four, or more different monomer units. Preferred copolymeric polysulfonates contain, besides sulfonic acid group-containing monomer(s), at least one monomer from the group of the unsaturated carboxylic acids.

Unsaturated carboxylic acids of formula R¹(R²)C═C(R³)COOH are especially preferably used, in which R¹ to R³, independently of one another, represent —H, —CH₃, a straight-chain or branched saturated alkyl functional group having 2 to 12 carbon atoms, a straight-chain or branched, mono- or polyunsaturated alkenyl functional group having 2 to 12 carbon atoms, with —NH₂, —OH, or —COOH substituted alkyl or alkenyl functional groups as defined above, or representing —COOH or —COOR⁴, where R⁴ is a saturated or unsaturated, straight-chain or branched hydrocarbon functional group having 1 to 12 carbon atoms.

Particularly preferred unsaturated carboxylic acids are acrylic acid, methacrylic acid, ethacrylic acid, α-chloroacrylic acid, a-cyanoacrylic acid, crotonic acid, α-phenylacrylic acid, maleic acid, maleic anhydride, fumaric acid, itaconic acid, citraconic acid, methylenemalonic acid, sorbic acid, cinnamic acid, or mixtures thereof. The unsaturated dicarboxylic acids can obviously also be used.

With respect to the sulfonic acid group-containing monomers, those of formula

R⁵(R⁶)C═C(R⁷)−X—SO₃H

are preferred, in which R⁵ to R⁷, independently of one another, represent —H, —CH₃, a straight-chain or branched saturated alkyl functional group having 2 to 12 carbon atoms, a straight-chain or branched, mono- or polyunsaturated alkenyl functional group having 2 to 12 carbon atoms, with —NH₂, —OH, or —COOH substituted alkyl or alkenyl functional groups, or representing —COOH or —COOR⁴, where R⁴ is a saturated or unsaturated, straight-chain or branched hydrocarbon functional group having 1 to 12 carbon atoms, and X represents an optionally present spacer group that is selected from —(CH₂)ₙ, where n=0 to 4, —COO—(CH₂)ₖ—, where k=1 to 6, —C(O)—NH—C(CH₃)₂—, —C(O)—NH—C(CH₃)₂—CH₂— and —C(O)—NH—CH(CH₃)—CH₂—.

Amongst said monomers, those of formulas

H₂C═CH—X—SO₃H

H₂C═C(CH₃)—X—SO₃H

HO₃S—X—(R⁶)C═C(R⁷)—X—SO₃H,

are preferred, in which R⁶ and R⁷, independently of one another, are selected from —H, —CH₃, —CH₂CH₃, —CH₂CH₂CH₃ and —CH(CH₃)₂, and X represents an optionally present spacer group that is selected from —(CH₂)ₙ—, where n=0 to 4, —COO—(CH₂)ₖ—, where k=1 to 6, —C(O)—NH—C(CH₃)₂—, —C(O)—NH—C(CH₃)₂—CH₂— and —C(O)—NH—CH(CH₃)—CH₂—.

Particularly preferred sulfonic acid group-containing monomers are in this case 1-acrylamido-1-propanesulfonic acid, 2-acrylamido-2-propanesulfonic acid, 2-acrylamido-2-methyl-1-propanesulfonic acid, 2-methacrylamido-2-methyl-1-propanesulfonic acid, 3-methacrylamido-2-hydroxy-propanesulfonic acid, allyl sulfonic acid, methallyl sulfonic acid, allyloxybenzene sulfonic acid, methallyloxybenzene sulfonic acid, 2-hydroxy-3-(2-propenyloxy)propanesulfonic acid, 2-methyl-2-propene-1-sulfonic acid, styrenesulfonic acid, vinylsulfonic acid, 3-sulfopropyl acrylate, 3-sulfopropyl methacrylate, sulfomethacrylamide, sulfomethylmethacrylamide, as well as mixtures of the above acids or water-soluble salts thereof.

The sulfonic acid groups can be present in the polymers in a fully or partially neutralized form, i.e., the acidic hydrogen atom of the sulfonic acid group can be replaced in some or all of the sulfonic acid groups with metal ions, preferably alkali metal ions, and in particular with sodium ions. The use of partially or fully neutralized sulfonic acid group-containing copolymers is preferred according to the invention.

In copolymers that contain only carboxylic acid group-containing monomers and sulfonic acid group-containing monomers, the monomer distribution of the copolymers that are preferably used according to the invention is preferably 5 to 95 wt. % in each case; particularly preferably, the proportion of the sulfonic acid group-containing monomer is 50 to 90 wt. %, and the proportion of the carboxylic acid group-containing monomer is 10 to 50 wt. %, with the monomers preferably being selected from those mentioned above.

The molar mass of the sulfo-copolymers that are preferably used according to the invention can be varied in order to adapt the characteristics of the polymers to the desired intended use. Preferred cleaning agents are characterized in that the copolymers have molar masses of from 2,000 to 200,000 gmol⁻¹, preferably 4,000 to 25,000 gmol⁻¹, and in particular 5,000 to 15,000 gmol⁻¹.

In particular polycarboxylates/polycarboxylic acids, polymeric polycarboxylates, aspartic acid, polyacetals, dextrins, further organic co-builders and the phosphonates already mentioned above as builders are specified as organic co-builders. These substance classes will be described hereinafter.

Usable organic builder substances are, for example, the polycarboxylic acids that can be used in the form of free acids and/or the sodium salts thereof, with polycarboxylic acids being understood to mean those carboxylic acids that carry more than one acid function. These include, for example, citric acid, adipic acid, succinic acid, glutaric acid, malic acid, tartaric acid, maleic acid, fumaric acid, saccharic acids, nitrilotriacetic acid (NTA), provided that such use is not objectionable for ecological reasons, and mixtures thereof. In addition to their builder effect, the free acids also typically exhibit the characteristics of an acidification component and thus also cause the automatic dishwashing agent to have a lower and milder pH. Particularly noteworthy here are citric acid, succinic acid, glutaric acid, adipic acid, gluconic acid, and any desired mixtures thereof.

The use of citric acid and/or citrates has proven to be particularly advantageous for the cleaning and rinsing performance of the agent according to the invention. Automatic dishwashing agents that are preferred according to the invention are therefore characterized in that the automatic dishwashing agent contains citric acid or a salt of the citric acid, and in that the percentage by weight of the citric acid or the salt of the citric acid is preferably more than 10 wt. %, preferably more than 15 wt. % and in particular between 20 and 40 wt. %.

Aminocarboxylic acids and/or the salts thereof are a further important class of phosphate-free builders. Methylglycinediacetic acid (MGDA) or the salts thereof, as well as glutaminediacetic acid (GLDA) or the salts thereof, or ethylenediaminediacetic acid or the salts thereof (EDDA), are particularly preferred representatives of this class. The content of said aminocarboxylic acids and/or the salts thereof can be between 0.1 and 15 wt. %, preferably between 0.5 and 10 wt. % and in particular between 0.5 and 6 wt. %, for example. Aminocarboxylic acids and/or the salts thereof can be used together with the above-mentioned builders, in particular together with the phosphate-free builders.

In addition to the polyethylene acrylates according to the invention, further polymeric compounds can be used.

The group of polymers includes in particular the washing or cleaning-active polymers, for example the rinsing polymers and/or the polymers that act as softeners. In general, cationic, anionic and amphoteric polymers can also be used in automatic dishwashing agents in addition to non-ionic polymers.

“Amphoteric polymers” in the context of the present invention also comprise negatively charged groups or monomer units in addition to a positively charged group in the polymer chain. These groups may be e.g. carboxylic acids, sulfonic acids or phosphonic acids.

Preferred amphoteric polymers that can be used come from the group of alkyl acrylamide/acrylic acid copolymers, alkyl acrylamide/methacrylic acid copolymers, alkyl acrylamide/methyl methacrylic acid copolymers, alkyl acrylamide/acrylic acid/alkylaminoalkyl (meth)acrylic acid copolymers, alkyl acrylamide/methacrylic acid/alkylaminoalkyl (meth)acrylic acid copolymers, alkyl acrylamide/methyl methacrylic acid/alkylaminoalkyl (meth)acrylic acid copolymers, alkyl acrylamide/alkyl methacrylate/alkylaminoethyl methacrylate/alkyl methacrylate copolymers and the copolymers of unsaturated carboxylic acids, cationically derived unsaturated carboxylic acids and optionally further ionic or non-ionogenic monomers.

Preferred zwitterionic polymers that can be used come from the group of acrylamidotrialkylammonium chloride/acrylic acid copolymers and the alkali and the ammonium salts thereof, acrylamidoalkyltrialkylammonium chloride/methacrylic acid copolymers and the alkali and the ammonium salts thereof, and methacryloyl ethyl betaine/methacrylate copolymers.

“Cationic polymers” are polymers carrying a positive charge in the polymer molecule. This can be realized for example by (alkyl)ammonium groupings or other positively charged groups present in the polymer chain. Particularly preferred cationic polymers come from the groups of quaternized cellulose derivates, polysiloxanes having quaternary groups, cationic guar derivatives, polymeric dimethyldiallylammonium salts and the copolymers thereof with esters and amides of acrylic acid and methacrylic acid, the copolymers of vinylpyrrolidone having quaternized derivatives of the dialkylaminoacrylate and -methacrylate, the vinylpyrrolidone-methylimidazolium-chloride copolymers, the quaternized polyvinyl alcohols or the polymers known under the INCI names polyquaternium-2, polyquaternium-17, polyquaternium-18 and polyquaternium-27.

The enzyme preparations or enzyme compositions of the invention contain at least one protease and optionally one or more further enzymes. Further suitable enzymes include, without being limited thereto, amylases, lipases, hemicellulases, cellulases, perhydrolases, or oxidoreductases, as well as, preferably, mixtures thereof. Said enzymes are in principle of natural origin; proceeding from the natural molecules, improved variants for use in cleaning agents are available which are preferably used accordingly. Agents according to the invention preferably contain enzymes in total amounts of from 1×10⁻⁶ wt. % to 5 wt. % based on active protein. The protein concentration can be determined with the aid of known methods, for example the BCA method or the Biuret method.

Proteases are some of the most significant enzymes for industry. They are the longest established enzymes for washing and cleaning agents, and are contained in virtually all modern, effective washing and cleaning agents. They bring about the decomposition of protein-containing contaminants on the items to be cleaned. In turn, amongst said proteases, subtili sin proteases (subtilases, subtilopeptidases, EC 3.4.21.62), which are serine proteases on account of the catalytically-effective amino acids, are particularly significant. They act as non-specific endopeptidases and hydrolyze any acid amide bonds that are inside peptides or proteins. The optimum pH thereof is mostly in the distinctly alkaline range. The article “Subtilases: Subtilisin-like Proteases” by R. Siezen, pages 75-95 in “Subtilisin enzymes”, published by R. Bott and C. Betzel, New York, 1996, gives an overview of this family, for example. Subtilases are naturally formed from microorganisms. In particular, the subtilisins formed from and secreted by Bacillus species are the most significant group of subtilases.

Examples of the subtilisin proteases preferably used in washing and cleaning agents are the subtilisins BPN' and Carlsberg, protease PB92, subtilisins 147 and 309, the protease from Bacillus lentus, in particular the protease from Bacillus lentus DSM 5483, subtilisin DY and the enzymes thermitase, proteinase K and proteases TW3 and TW7, which belong to the subtilases but no longer to the subtilisins in the narrower sense, and variants of said proteases having an amino acid sequence that has been altered with respect to the starting protease. Proteases are altered in a targeted manner or by chance using methods known from the prior art, and are thus optimized for use in washing and cleaning agents, for example. This includes localized mutagenesis, deletion or insertion mutagenesis, or fusion with other proteins or protein parts. Appropriately optimized variants are therefore known for the majority of proteases known from the prior art.

Examples of amylases that can be used according to the invention are α-amylases from Bacillus licheniformis, from B. amyloliquefaciens, from B. stearothermophilus, from Aspergillus niger, and A. oryzae, as well as the further developments of said amylases that have been improved for use in cleaning agents. Others that are particularly noteworthy for this purpose are the α-amylases from Bacillus sp. A 7-7 (DSM 12368) and cyclodextrin glucanotransferase (CGTase) from B. agaradherens (DSM 9948).

Furthermore, lipases or cutinases can be used according to the invention, in particular due to their triglyceride-cleaving activities, but also in order to produce peracids in situ from suitable precursors. These include, for example, the lipases that could originally be obtained from Humicola lanuginosa (Thermomyces lanuginosus) and those that have been further developed, particularly those with the amino acid exchange D96L.

Moreover, enzymes can be used which can be grouped together under the term “hemicellulases”. These include, for example, mannanases, xanthan lyases, pectin lyases (=pectinases), pectinesterases, pectate lyases, xyloglucanases (=xylanases), pullulanases, and β-glucanases.

In order to increase the bleaching effect, oxidoreductases such as oxidases, oxygenases, catalases, peroxidases such as halo-, chloro-, bromo-, lignin, glucose, or manganese peroxidases, dioxygenases or laccases (phenoloxidases, polyphenoloxidases) can be used according to the invention. Advantageously, organic, particularly preferably aromatic compounds that interact with the enzymes are additionally added in order to potentiate the activity of the relevant oxidoreductases (enhancers) or, in the event of greatly differing redox potentials, to ensure the flow of electrons between the oxidizing enzymes and the contaminants (mediators).

A protein and/or enzyme can be protected, especially during storage, against damage such as inactivation, denaturing, or decomposition caused by, for example, physical influences, oxidation or proteolytic cleavage. When the proteins and/or enzymes are obtained microbially, it is especially preferable for proteolysis to be inhibited, particularly if the agents also contain proteases. Cleaning agents may contain stabilizers for this purpose; the provision of such agents constitutes a preferred embodiment of the present invention.

Cleaning-active proteases and amylases are generally not made available in the form of the pure protein, but rather in the form of stabilized, storable and transportable preparations. These pre-packaged preparations include, for example, the solid preparations obtained by granulation, extrusion, or lyophilization or, in particular in the case of liquid or gel-type agents, solutions of the enzymes, advantageously maximally concentrated, low-moisture, and/or supplemented with stabilizers or other auxiliaries.

Alternatively, the enzymes can also be encapsulated, for both the solid and the liquid dosage form, for example by spray-drying or extrusion of the enzyme solution together with a preferably natural polymer or in the form of capsules, for example those in which the enzymes are enclosed in a set gel, or in those of the core-shell type, in which an enzyme-containing core is coated with a water-, air-, and/or chemical-impermeable protective layer. In the case of overlaid layers, other active ingredients, such as stabilizers, emulsifiers, pigments, bleaching agents or dyes, can be additionally applied. Such capsules are applied using inherently known methods, for example by shaking or roll granulation or in fluidized bed processes. Such granulates are advantageously low in dust, for example due to the application of polymeric film-formers, and stable in storage due to the coating.

Moreover, it is possible to formulate two or more enzymes together, so that a single granulate exhibits a plurality of enzyme activities.

As is clear from the preceding remarks, the enzyme protein forms only a fraction of the total weight of conventional enzyme preparations. Protease and amylase preparations that are preferably used according to the invention contain between 0.1 and 40 wt. %, preferably between 0.2 and 30 wt. %, particularly preferably between 0.4 and 20 wt. %, and in particular between 0.8 and 10 wt. % of the enzyme protein.

In particular, those cleaning agents are preferred which contain, in each case based on the total weight thereof, 0.1 to 12 wt. %, preferably 0.2 to 10 wt. %, and in particular 0.5 to 8 wt. % of the enzyme preparations.

The compositions described herein may also contain enzyme stabilizers. Reversible protease inhibitors are one group of stabilizers. Benzamidine hydrochloride, borax, boric acids, boronic acids or the salts or esters thereof are often used for this purpose, including in particular derivatives having aromatic groups, such as ortho-, meta- or para-substituted phenylboronic acids, in particular 4-formylphenylboronic acid, or the salts or esters of said compounds. Peptide aldehydes, i.e. oligopeptides having a reduced C-terminus, in particular those consisting of 2 to 50 monomers, are used for this purpose. Peptidic, reversible protease inhibitors include, inter alia, ovomucoid and leupeptin. Specific, reversible peptide inhibitors for the subtilisin protease and fusion proteins consisting of proteases and specific peptide inhibitors are also suitable for this purpose.

Further enzyme stabilizers are amino alcohols such as mono-, di-, triethanol- and -propanolamine and mixtures thereof, aliphatic carboxylic acids up to C₁₂, such as succinic acid, other dicarboxylic acids or salts of said acids. End-capped fatty acid amide alkoxylates are also suitable for this purpose. Specific organic acids used as builders make it possible, as disclosed in WO 97/18287, to additionally stabilize a contained enzyme.

Further enzyme stabilizers are known to a skilled person from the prior art.

Bleaching agents are washing- or cleaning-reactive substances. From the group of compounds which act as bleaching agents and yield H₂O₂ in water, sodium percarbonate, sodium perborate tetrahydrate and sodium perborate monohydrate are of particular significance. Further examples of bleaching agents which may be used are peroxypyrophosphates, citrate perhydrates as well as H₂O₂-yielding peracid salts or peracids, such as perbenzoates, peroxophthalates, diperazelaic acid, phthaloiminoperacid or diperdodecane diacid. In addition, all other inorganic or organic peroxy bleaching agents known to a skilled person from the prior art can be used. The percarbonates and, in this case, in particular sodium percarbonate are particularly preferred as bleaching agents according to the invention.

According to the invention, automatic dishwashing agents are preferred which contain 1 to 35 wt. %, preferably 2.5 to 30 wt. %, particularly preferably 3.5 to 20 wt. % and in particular 5 to 15 wt. % bleaching agent, preferably sodium percarbonate.

In various embodiments of the invention, the automatic dishwashing agent additionally contains at least one bleach activator. Compounds which, under perhydrolysis conditions, result in aliphatic peroxocarboxylic acids having preferably 1 to 10 C atoms, in particular 2 to 4 C atoms, and/or optionally substituted perbenzoic acid, may be used as bleach activators. From all the bleach activators known to a skilled person from the prior art, polyacylated alkylendiamines, in particular tetraacetylethylenediamine (TAED), acylated triazine derivates, in particular 1,5-diacetyl-2,4-dioxohexahydro-1,3,5-triazine (DADHT), acylated glycolurils, in particular tetraacetylglycoluril (TAGU), N-acylimides, in particular N-nonanoylsuccinimide (NOSI), acylated phenol sulfonates, in particular n-nonanoyl or isononanoyl oxybenzene sulfonate (n- or iso-NOBS), are particularly preferably used. Combinations of conventional bleach activators may also be used. TAED, in particular in combination with a percarbonate bleaching agent, preferably sodium percarbonate, are very particularly preferred as bleach activators according to the invention.

Said bleach activators are preferably used in amounts of up to 10 wt. %, in particular 0.1 wt. % to 8 wt. %, especially 2 to 8 wt. % and particularly preferably 2 to 6 wt. %, in each case based on the total weight of the bleach-activator-containing agent.

In general, the pH of the cleaning agent can be set using conventional pH regulators, the pH being selected depending on the desired intended use. In various embodiments, the pH is in a range of from 5.5 to 10.5, preferably 5.5 to 9.5, more preferably 7 to 9, in particular greater than 7, especially in the range of from 7.5 to 8.5. Acids and/or alkalis can be used as pH adjusters, preferably alkalis. Suitable acids are in particular organic acids such as acetic acid, citric acid, glycolic acid, lactic acid, succinic acid, adipic acid, malic acid, tartaric acid and gluconic acid, or also sulfamic acid. In addition, however, the mineral acids hydrochloric acid, sulfuric acid and nitric acid, or mixtures thereof, can also be used. Suitable bases come from the group of alkali and alkaline-earth metal hydroxides and carbonates, in particular the alkali metal hydroxides, from which potassium hydroxide and especially sodium hydroxide are preferred. A volatile alkali, for example in the form of ammonia and/or alkanolamines, which can contain up to 9 C atoms in the molecule, is particularly preferred, however. The alkanolamine is preferably selected from the group consisting of mono-, di-, triethanol- and propanolamine and mixtures thereof. The alkanolamine is preferably contained in agents according to the invention in an amount of from 0.5 to 10 wt. %, in particular in an amount of from 1 to 6 wt. %.

In order to set and/or stabilize the pH, the agent according to the invention can also contain one or more buffer substances (INCI Buffering Agents), usually in amounts of from 0.001 to 5 wt. %. Buffer substances that are also complexing agents or even chelating agents (chelators, INCI Chelating Agents) are preferred. Particularly preferred buffer substances are citric acid or citrates, in particular the sodium and potassium citrates, for example trisodium citrate 2H₂O and tripotassium citrate H₂O.

Glass corrosion inhibitors prevent opacification, streaks and scratches, and also prevent the iridescence of the glass surface of automatically washed glass. Preferred glass corrosion inhibitors come from the group of magnesium and zinc salts, and magnesium and zinc complexes. In the context of the present invention, the content of zinc salt in dishwashing agents is preferably between 0.1 and 5 wt. %, more preferably between 0.2 and 4 wt. % and in particular between 0.4 and 3 wt. %, or the content of zinc in oxidized form (calculated as Zn²⁺) is between 0.01 and 1 wt. %, preferably between 0.02 and 0.5 wt. % and in particular between 0.04 and 0.2 wt. %, in each case based on the total weight of the glass corrosion inhibitor-containing agent.

Individual fragrance compounds, e.g. synthetic products of the ester, ether, aldehyde, ketone, alcohol, and hydrocarbon types, can be used as perfume oils or scents in the context of the present invention. Preferably, however, mixtures of different odorants are used, which together produce an appealing odorous note. Such perfume oils can also contain natural fragrance mixtures, as are obtainable from plant sources, e.g. pine, citrus, jasmine, patchouli, rose or ylang-ylang oil.

Preservatives may also be contained in the agents. For example preservatives from the groups of the alcohols, aldehydes, antimicrobial acids and/or the salts thereof, carboxylic acid esters, acid amides, phenols, phenol derivatives, diphenyls, diphenyl alkanes, urea derivatives, oxygen and nitrogen acetals and methylals, benzamidines, isothiazoles and the derivatives thereof such as isothiazolins and isothiazolinones, phthalimide derivatives, pyridine derivatives, antimicrobial surface-active compounds, guanidines, antimicrobial amphoteric compounds, quinolines, 1,2-dibromo-2,4-dicyanobutane, iodo-2-propynyl-butylcarbamate, iodine, iodophors, and peroxides are suitable. Preferred antimicrobial active ingredients are preferably selected from the group including ethanol, n-propanol, i-propanol, 1,3-butanediol, phenoxyethanol, 1,2-propylene glycol, glycerol, undecylenic acid, citric acid, lactic acid, benzoic acid, salicylic acid, thymol, 2-benzyl-4-chlorophenol, 2,2′-methylene-bis-(6-bromo-4-chlorophenol), 2,4,4′-trichloro-2′-hydroxydiphenyl ether, N-(4-chlorophenyl)-N-(3,4-dichlorophenyl)urea, N,N′ -(1,10-decandiyldi-1-pyridinyl-4-ylidene)-bis-(1-octanamine) dihydrochloride, N,N′ -bis-(4-chlorophenyl)-3,12-diimino-2,4, 11,13 -tetraazatetradecandiimidamide, antimicrobial quaternary surface-active compounds and guanidines. Particularly preferred preservatives are, however, selected from the group including salicylic acid, quaternary surfactants, and in particular benzalkonium chloride and isothiazoles and the derivatives thereof such as isothiazolins and isothiazolinones.

In general, automatic dishwashing agents described herein can be packaged in various ways. The agents may be present in solid or liquid form, or as a combination of solid and liquid offerings. In particular powder, granulate, extrudate and compacted material, in particular tablets, are suitable as solid offerings. The liquid offerings based on water and/or organic solvents may be present in a thickened form, in the form of gels. The agents may be packaged in the form of single-phase or multiphase products. The individual phases of multiphase agents may have the same or different states of aggregation.

The dishwashing agents may be present as shaped bodies. In order to facilitate the decomposition of prefabricated shaped bodies of this kind, it is possible to work disintegration auxiliaries, known as tablet disintegrants, into said agents in order to reduce the decomposition times. Tablet disintegrants or decomposition accelerators are understood to be auxiliaries which ensure the rapid decomposition of tablets in water or other media and ensure swift release of the active ingredients. Disintegration auxiliaries can preferably be used in amounts of from 0.5 to 10 wt. %, preferably 3 to 7 wt. % and in particular 4 to 6 wt. %, in each case based on the total weight of the disintegration auxiliary-containing agent.

The dishwashing agents described herein are preferably pre-packaged into dosing units. Said dosing units preferably include the amount of washing- or cleaning-reactive substances required for one cleaning cycle. Preferred dosing units preferably have a weight between 12 and 30 g, preferably between 14 and 26 g and in particular between 16 and 22 g. The volume of the above-mentioned dosing units and the three-dimensional shape thereof are preferably selected such that it is ensured that the pre-packaged units can be dosed by the dosing chamber of a dishwasher. The volume of the dosing unit is therefore preferably between 10 and 35 ml, preferably between 12 and 30 ml.

The automatic dishwashing agents, in particular the prefabricated dosing units, preferably comprise a water-soluble wrapping.

The water-soluble wrapping is preferably made from a water-soluble film material, which is selected from the group consisting of polymers or polymer mixtures. The wrapping may be made up of one or of two or more layers of the water-soluble film material. The water-soluble film material of the first layer and of the additional layers, if present, may be the same or different. Films which can be bonded and/or sealed, after being filled with an agent, to form packaging such as tubes or sachets are particularly preferred, for example.

The water-soluble packaging can comprise one or more chambers. The agent may be contained in one or more chambers, if present, of the water-soluble wrapping. The amount of agent preferably corresponds to the full or half dose required for one washing cycle.

It is preferable for the water-soluble wrapping to contain polyvinyl alcohol or a polyvinyl alcohol copolymer. Water-soluble wrappings containing polyvinyl alcohol or a polyvinyl alcohol copolymer exhibit good stability at a sufficiently high level of water solubility, in particular cold-water solubility.

Suitable water-soluble films for producing the water-soluble wrapping are preferably based on a polyvinyl alcohol or a polyvinyl alcohol copolymer of which the molecular weight is in the range of from 10,000 to 1,000,000 gmol⁻¹, preferably 20,000 to 500,000 gmol⁻¹, particularly preferably 30,000 to 100,000 gmol⁻¹ and in particular 40,000 to 80,000 gmol⁻¹.

Polyvinyl alcohol is usually produced by hydrolysis of polyvinyl acetate, since the direct synthesis route is not possible. The same applies to polyvinyl alcohol copolymers, which are produced accordingly from polyvinyl acetate copolymers. It is preferable for at least one layer of the water-soluble wrapping to include a polyvinyl alcohol of which the degree of hydrolysis is 70 to 100 mol. %, preferably 80 to 90 mol. %, particularly preferably 81 to 89 mol. %, and in particular 82 to 88 mol. %.

In addition, a polymer selected from the group including (meth)acrylic acid-containing (co)polymers, polyacrylamide, oxazoline polymers, polystyrene sulfonates, polyurethanes, polyesters, polyethers, polylactic acid or mixtures of said polymers may be added to a polyvinyl alcohol-containing film material that is suitable for producing the water-soluble wrapping. Polylactic acids are a preferred additional polymer.

Preferred polyvinyl alcohol copolymers include, in addition to vinyl alcohol, dicarboxylic acids as further monomers. Suitable dicarboxylic acids are itaconic acid, malonic acid, succinic acid and mixtures thereof, with itaconic acid being preferred.

Polyvinyl alcohol copolymers which include, in addition to vinyl alcohol, an ethylenically unsaturated carboxylic acid, or the salt or ester thereof, are also preferred. Polyvinyl alcohol copolymers of this kind particularly preferably contain, in addition to vinyl alcohol, acrylic acid, methacrylic acid, acrylic acid ester, methacrylic acid ester or mixtures thereof.

It may be preferable for the film material to contain further additives. The film material may contain plasticizers such as dipropylene glycol, ethylene glycol, diethylene glycol, propylene glycol, glycerol, sorbitol, mannitol or mixtures thereof, for example. Further additives include for example release aids, fillers, cross-linking agents, surfactants, anti-oxidants, UV absorbers, anti-blocking agents, anti-adhesive agents or mixtures thereof.

Suitable water-soluble films for use in the water-soluble wrappings of the water-soluble packaging according to the invention are films which are sold by MonoSol LLC, for example under the designations M8630, C8400 or M8900. Other suitable films include films having the names Solublon® PT, Solublon® GA, Solublon® KC or Solublon® KL from Aicello Chemical Europe GmbH, or the VF-HP films from Kuraray.

The corresponding use of the automatic dishwashing agent according to the invention is also an object of the invention. The invention also relates to a dishwashing method, in particular to an automatic dishwashing method, in which a dishwashing agent according to the invention is used. The object of the present application is therefore also a method for cleaning dishes in a dishwasher, in which method the agent according to the invention is dispensed into the interior of a dishwasher while a dishwashing program is running, before the main washing cycle begins or during the main washing cycle. The agent according to the invention can be dispensed or inserted into the interior of the dishwasher manually, but the agent is preferably dosed into the interior of the dishwasher by means of the dosing chamber.

The embodiments described in connection with the agents according to the invention are readily transferable to the methods and uses according to the invention, and vice versa.

### EXAMPLES

Example 1: Various formulations were prepared according to the following table, and were compressed to form tablets weighing 20 g. The amounts are provided in wt. % of the active substance. E1 is a composition according to the invention containing PE/AA copolymer, C1 is a conventional formulation that is standard on the market, and C2 is formulation that is standard on the market without rinse aids. Finally, C3 corresponds to C2, but to which a C₁₀₋₁₂ alcohol having 5 EO/5 PO units was added as a rinsing surfactant.

TABLE 1
Composition of the automatic dishwashing agent

| | E1 | C1 | C2 | C3 |
|---|---|---|---|---|
| Phosphate | 18.00-45.00 | 18.00-45.00 | 18.00-45.00 | 18.00-45.00 |
| Phosphonate | 0.00-2.00 | 0.00-2.00 | 0.00-2.00 | 0.00-2.00 |
| Silicate | 0.00-6.00 | 0.00-6.00 | 0.00-6.00 | 0.00-6.00 |
| Soda | 12.00-20.00 | 12.00-20.00 | 12.00-20.00 | 12.00-20.00 |
| Sodium percarbonate | 10.00-16.00 | 10.00-16.00 | 10.00-16.00 | 10.00-16.00 |
| Bleach catalyst | 0.01-1.5 | 0.01-1.5 | 0.01-1.5 | 0.01-1.5 |
| TAED | 1.00-2.70 | 1.00-2.70 | 1.00-2.70 | 1.00-2.70 |
| Non-ionic surfactants | — | 2.00-10.00 | — | — |
| C₁₀₋₁₂ alcohol having 5 EO/5 PO | — | — | — | 2.00-10.00 |
| PE-AA copolymer | 5.00 | — | — | — |
| Sulfopolymer | 5.00-10.00 | 5.00-10.00 | 5.00-10.00 | 5.00-10.00 |
| Acrylate polymer | 0.00-6.00 | 0.00-6.00 | 0.00-6.00 | 0.00-6.00 |
| PEG 4000 powder | 0.00-2.00 | 0.00-2.00 | 0.00-2.00 | 0.00-2.00 |
| Modified polycarboxylate | 0.00-1.50 | 0.00-1.50 | 0.00-1.50 | 0.00-1.50 |
| Protease | 0.50-7.00 | 0.50-7.00 | 0.50-7.00 | 0.50-7.00 |
| Amylase | 0.10-2.50 | 0.10-2.50 | 0.10-2.50 | 0.10-2.50 |
| Perfume | 0.05-0.20 | 0.05-0.20 | 0.05-0.20 | 0.05-0.20 |
| Dye | 0.50-2.00 | 0.50-2.00 | 0.50-2.00 | 0.50-2.00 |
| Water-free zinc acetate | 0.15-0.35 | 0.15-0.35 | 0.15-0.35 | 0.15-0.35 |
| Sodium sulfate | 0.00-10.00 | 0.00-10.00 | 0.00-10.00 | 0.00-10.00 |

PE-AA copolymer = (poly)ethylene acrylic acid copolymer according to the invention
Modified polycarboxylate = Sokalan HP 11

### Example 2: Rinse Test

In order to determine the rinse effect, selected and specified dishes are washed 4 times and visually inspected after the 2nd, 3rd and 4th washing cycle. The first washing cycle is used to condition the dishes. As the parameters, rinsing grades are awarded based on the visual appearance of the dried washware (porcelain, glass, plastics parts and stainless steel). A tablet of the above-mentioned formulation is dosed, and 100 g of dirt is dosed per washing cycle in order to simulate a normal dirty load.

The filming is determined, in a time-reduced manner, in a Bosch SMS 68M12 dishwasher using the 50° C. eco program. Water hardness 21° dH. After the washing cycle has ended, the machine is fully opened for 30 min, and the rinse effect is then visually determined in a black box (black-painted room, D6500 daylight lamp). Any dried-on water droplets, streaks, coatings and films remaining on the dishes and cutlery are assessed on a scale of from 1-10. 10 indicates no films, 1 indicates significant film-formation.

The following result was achieved by adding the polymer according to the invention:

TABLE 2
Rinse result

| | Glass | Porcelain | Tupperware |
|---|---|---|---|
| C1 | 2.3 | 3 | 5.7 |
| C2 | 3 | 4.4 | 6 |
| C3 | 4.1 | 4.3 | 10 |
| E1 | 4.4 | 4.9 | 8.3 |

It is clear that adding 1 g of copolymer according to the invention leads to an improvement in particular in comparison with the reference without rinsing surfactants (C2) and with a formulation available on the market (C1). The new polymer can also present advantages in comparison with a formulation having a standard rinsing surfactant (C3).

What is claimed is:

1. A dishwashing agent comprising, based on the total weight of the dishwashing agent, 0.1 to 25.0 wt. % of a copolymer that can be obtained by polymerization of
a) 70-95 mol. % of at least one C₂₋₄ alkene monomer; and
b) 5-30 mol. % of at least one ethylenically unsaturated C₃₋₈ carboxylic acid monomer or a salt thereof

2. The dishwashing agent according to claim 1, characterized in that the copolymer can be obtained by polymerization of ethylene and acrylic acid.

3. The dishwashing agent according to claim 1, characterized in that the copolymer is neutralized, in whole or at least in part, using suitable alkaline reagents.

4. The dishwashing agent according to claim 1, characterized in that the molecular weight M_{w} of the copolymer is-in the range from 10,000-1,000,000 based on the number average (Mn).

5. The dishwashing agent according to claim 1, characterized in that the copolymer is contained in an amount of approximately 5.0 wt. % based on the total weight of the dishwashing agent.

6. The dishwashing agent according to claim 1, characterized in that the copolymer is contained in the dishwashing agent in an absolute amount of from 0.1 to 5 g/job.

7. The dishwashing agent according to claim 1, characterized in that the dishwashing agent contains at least one further component selected from the group consisting of surfactants, builders, enzymes, thickeners, sequestering agents, electrolytes, corrosion inhibitors, silver protectants, glass corrosion inhibitors, foam inhibitors, dyes, fragrances, bitterns, antimicrobial active ingredients and disintegration auxiliaries.

8. The use of a dishwashing agent according to claim 1 in an automatic dishwashing method.

9. An automatic dishwashing method, characterized in that a dishwashing agent according to claim 1 is used.

10. The use of a copolymer which can be obtained by polymerization of
a) 70-95 mol. % of at least one C₂₋₄ alkene monomer; and
b) 5-30 mol. % of at least one ethylenically unsaturated C₃₋₈ carboxylic acid monomer, or a salt thereof,
for improving the rinsing performance of an automatic dishwashing agent.

11. The dishwashing agent according to claim 1, characterized in that the agent is an automatic dishwashing agent.

12. The dishwashing agent according to claim 1, comprising, based on the total weight of the dishwashing agent, 0.5 to 10 wt. %, of a copolymer that can be obtained by polymerization of
a) 75-92 mol. % of ethylene or propylene; and
b) 8-25 mol. % of acrylic or methacrylic acid, or a salt thereof

13. The dishwashing agent according to claim 1, comprising, based on the total weight of the dishwashing agent, 0.5 to 10 wt. %, of a copolymer that can be obtained by polymerization of
a) 77-85 mol. % of ethylene or propylene; and
b) 15-23 mol. % of acrylic or methacrylic acid, or a salt thereof

14. The dishwashing agent according to claim 6, characterized in that the copolymer is contained in the dishwashing agent in an absolute amount of 0.1 to 2 g/job.

15. The dishwashing agent according to claim 6, characterized in that the copolymer is contained in the dishwashing agent in an absolute amount of approximately 1 g/job.

16. The dishwashing agent according to claim 7, characterized in that the dishwashing agent contains at least two further components, selected from the group consisting of non-ionic or anionic surfactants, builders, enzymes, thickeners, sequestering agents, electrolytes, silver protectants, glass corrosion inhibitors, foam inhibitors, dyes, fragrances, bitterns, antimicrobial active ingredients and disintegration auxiliaries.

17. The use of a copolymer according to claim 10 which can be obtained by polymerization of
a) 75-92 mol. % of ethylene or propylene; and
b) 8-25 mol. % of acrylic or methacrylic acid, or a salt thereof,
for improving the rinsing performance of an automatic dishwashing agent.

18. The use of a copolymer according to claim 10 which can be obtained by polymerization of
a) 77-85 mol. % of ethylene or propylene; and
b) 15-23 mol. % of acrylic or methacrylic acid, or a salt thereof,
for improving the rinsing performance of an automatic dishwashing agent.
